(19) United States
(12) Patent Application Publication
(10) Pub. No.: US 2002/0074189 A1
(43) Pub. Date: Jun. 20, 2002

(54) Stairlift with guide

(75) Inventors: Martinus J. Hester, Heerhugowaard (NL); Dennis Vroegindeweij, JL Hoofddorp (NL)

Correspondence Address: Richard L. Byrne, WEBB ZIESENHEIM LOGSDON ORKIN & HANSON, P.C., 700 Koppers Building, 436 Seventh Avenue, Pittsburgh, PA, 15219-1818, US

(73) Assignee: Freelift B.V., Heerhugowaard (NL)

(21) Appl. No.: 09/975,329

(22) Filed: Oct. 11, 2001

(30) Foreign Application Priority Data
Oct. 12, 2000 (DE) 1016396

(51) Int. Cl. B66B 9/08

(52) U.S. Cl. 187/201; 187/245; 187/200

(57) ABSTRACT

The present invention relates to a device for transporting persons along a staircase, comprising:

a frame displaceable along a guide,

a drive to be selectively set into operation for displacing the frame along the guide; and

a chair on the frame on which a person for transporting can be seated. The seat can comprise a seat part and a back rest and optionally at least one arm rest, wherein at least the seat part on the side directed toward the back rest can be pivoted up and downward in a pivoting movement on a horizontal pivot axis and forms a guide during standing up or sitting down.

The present invention relates to a device generally known as a stairlift for transporting persons along a staircase, comprising:

a frame displaceable along a guide,

a drive to be selectively set into operation for displacing the frame along the guide; and

a chair on the frame on which a person for transporting can be seated, which chair comprises a seat part and a back rest.

Such devices are generally known, wherein the chair on the frame is fixed thereon in stationary manner.

Such known devices have the drawback that at the staircase along which the device extends, in particular the guide thereof, there are hazards for persons who wish to sit down on or stand up from the stairlift. This is a danger precisely for those people who have to make use of a stairlift, since they are already not very good on their legs.

The invention has for its object to obviate the above stated problems of the known devices, for which purpose a device according to the present invention is distinguished in that at least the seat part on the side directed toward the back rest can be pivoted upward in a pivoting movement on a horizontal pivot axis and forms a guide during standing up or sitting down.

The back rest is preferably connected to the seat part and can be co-displaced in substantially upright position with the seat part. The chair of the device according to the present invention thus forms a guide during standing or sitting, whereby the risks and hazards, particularly at the top of a staircase along which the device extends, that a person with walking difficulties can fall are reduced. When in the preferred embodiment the back rest co-displaces, this represents an additional safety measure, wherein the user is also supported in the back. If the chair comprises arm rests, these are preferably connected to the back rest so as to follow the movement thereof or to pass through their own movement relative thereto so as to further improve the guiding during standing or sitting.

In a preferred embodiment the frame and the seat part are mutually connected with a guide mechanism for guiding the movement of at least the seat part relative to the frame. The guide mechanism defines the movement of the seat part, and optionally the back rest and optionally the arm rests. A path can be defined in such a guide mechanism which can follow and guide the natural movement of a person as closely as possible. This means in practice that the pivoting movement on the pivot axis is one wherein the pivot axis is for instance non-stationary and the pivoting movement substantially follows the movement in space of the pivot points of the legs of a user in the pelvis thereof. A corresponding guiding which is ergonomically as correct as possible is thus provided during standing up and sitting down, so that the user can be guided during the entire action of sitting down or standing up.

If the back rest (and optionally the arm rests) co-displaces, the back rest and the seat part (and optionally the arm rests) are preferably connected by means of the guide mechanism such that the back rest (and optionally the arm rests) preferably co-displaces in substantially upright position with the seat part. This also provides a further improvement in the guiding during sitting or standing.

In embodiments with a guide mechanism, this latter can comprise a drive. A drive has the advantage that the person sitting down on the device, and in particular the chair thereof, or rising therefrom, need use as little strength as possible for this purpose. Alternatively, when the guide mechanism does not comprise a drive, the guide mechanism can be designed such that a weight displacement corresponding to standing up or sitting down by a user is converted into the guiding movement. Such a weight displacement thus in fact forms the drive without separate measures having to be taken for this purpose other than a suitable embodiment of the guide mechanism.

In a preferred embodiment a guide mechanism can comprise a rod construction coupled by means of hinges. Such an embodiment is simple to realize, so that the guiding function during standing up and sitting down is also readily realized.

In a rod construction coupled by means of hinges the rods are preferably flat and plate-like and folded adjacently of each other into the guide mechanism in a position of the seat part folded down onto the frame. In such an embodiment a minimum amount of space is taken up between the frame and the seat part, which is favourable because very little space is available for a guide mechanism at that location owing to the presence there of the drive for displacing the frame along the guide.

The hinges in the rod construction preferably form a parallelogram, of which two hinges lying at corner points of the parallelogram are fixed to the frame in stationary manner relative thereto, and the other two hinge points are coupled to the seat surface. Upright co-displacement of the back rest with the seat surface in the guiding movement is thus ensured.

It is noted that such guide mechanisms according to the present invention can be realized in very many different ways. Space-saving between the frame and the seat part and/or the back rest is an important factor here.

In several of the sub-claims and the following figure description attention is paid to a few possible embodiments of such guide mechanisms.

In a further preferred embodiment a device comprises a lock to be actuated selectively and acting on at least the seat part, which lock can be actuated during transport of the frame with the chair thereon along the guide. In an embodiment with an active drive, this drive can form the lock by preventing this drive from being set into operation. In an embodiment wherein a guide mechanism is adapted to bring about the guiding function in response to weight displacements, a more active locking is recommended so as to prevent a person, who displaces his weight on the seat surface during the transport but who does not intend to stand up, from thereby initiating the guiding function. This could result in accidents.

In a further preferred embodiment the device can be provided with a blocking to be actuated selectively and acting on the frame, with which blocking transport along the guide can be prevented if the seat part is not folded down. This also increases the safety of the device.

A number of embodiments of a device according to the present invention will be described hereinbelow with reference to the annexed drawings, in which:

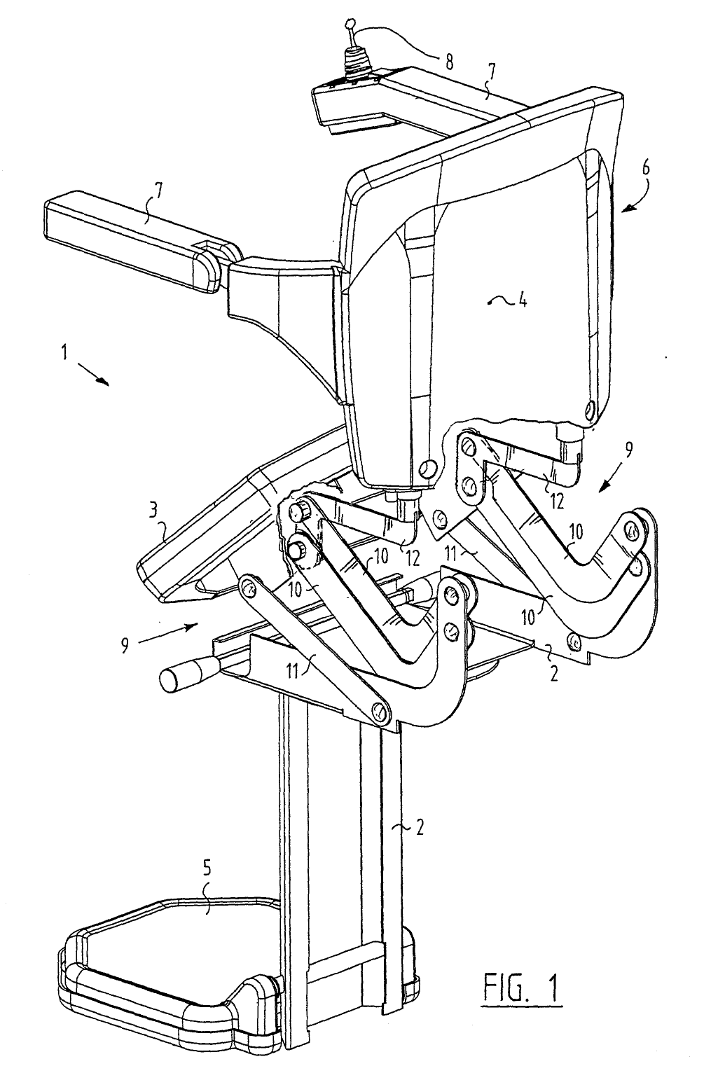

FIGS. 1-3 show the configuration and operation of a first embodiment;

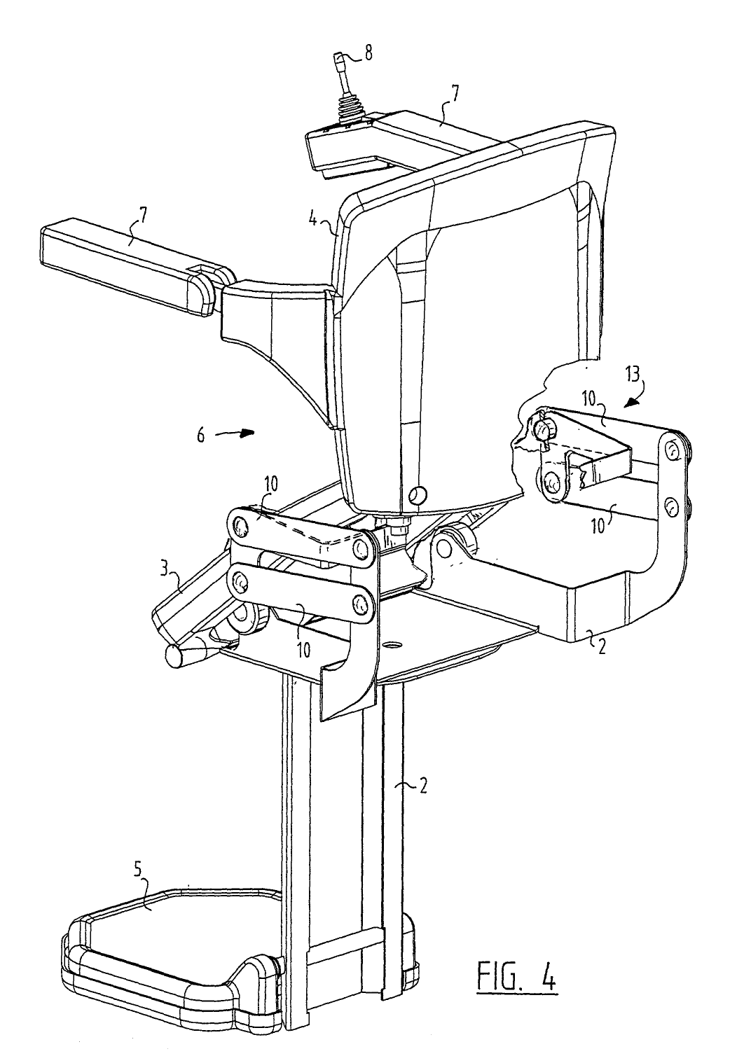

FIGS. 4-6 show the configuration and operation of a second embodiment;

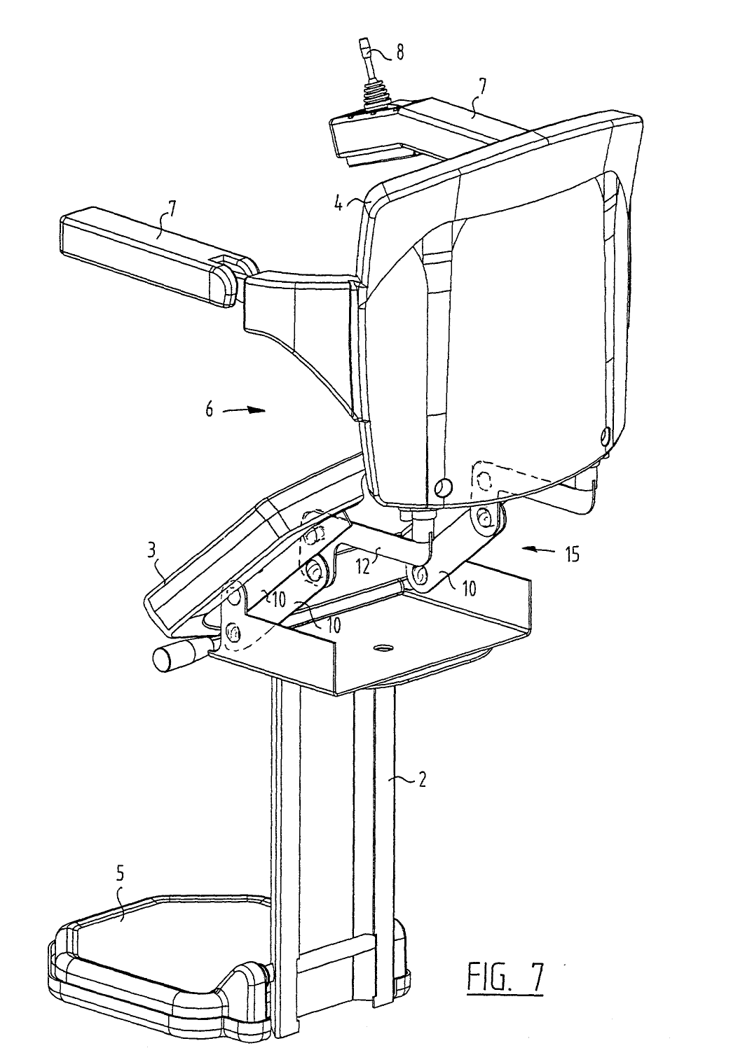

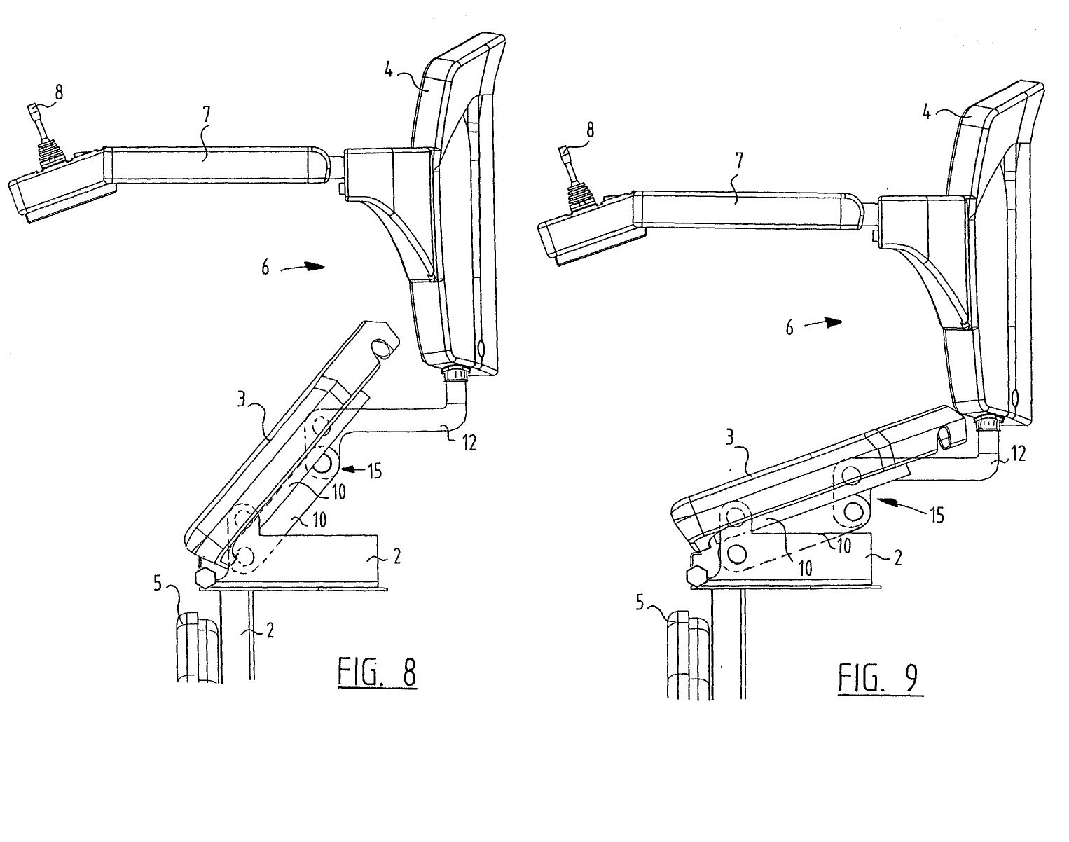

FIGS. 7-9 show the configuration and operation of a third embodiment; and

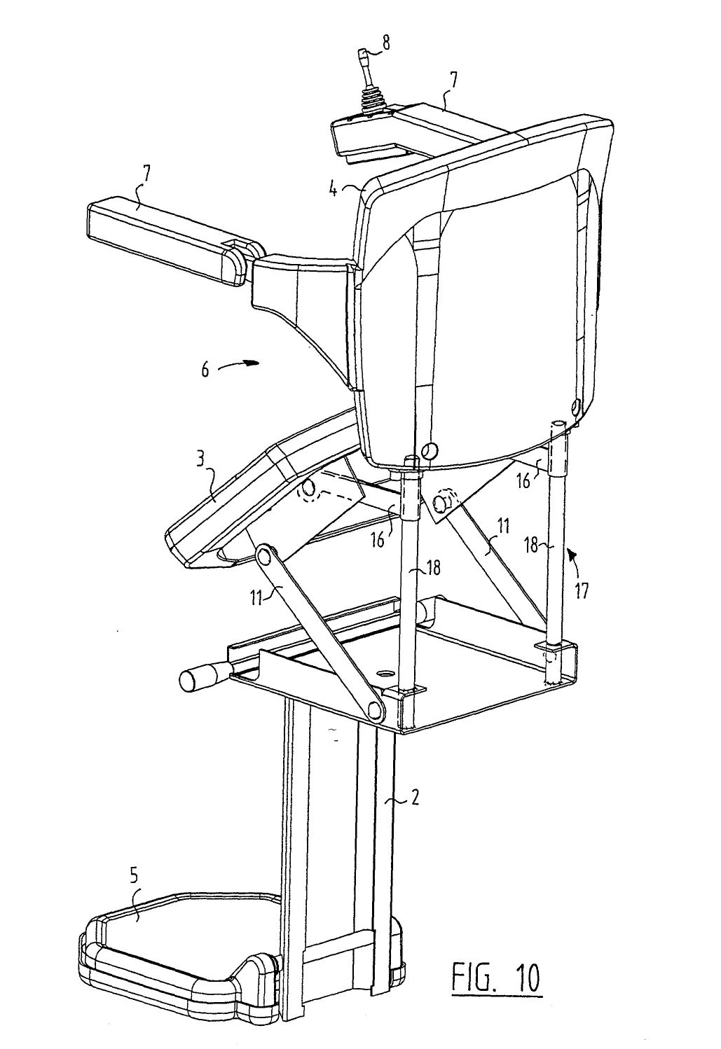

FIGS. 10-12 show the configuration and operation of a fourth embodiment.

In the preferred embodiments associated with the various embodiments the same reference numerals are used for identical or similar components, parts and functional assemblies.

It is noted prior to the further description of the annexed drawings that the various embodiments shown in the figures differ from each other substantially in respect of the design of the guide mechanism applied therein.

FIGS. 1-3 show a first preferred embodiment of a stairlift 1 according to the present invention. For the sake of simplicity in the drawing the drive of stairlift 1 for displacing thereof along a guide is not shown.

The stairlift comprises a frame 2 on which respectively a seat part 3, a back rest 4 and a footrest 5 are arranged, wherein seat part 3 and back rest 4 together form a chair 6. Two arm rests 7 are arranged on back rest 4. Arranged on the right-hand arm rest 7 shown in FIG. 1 is a control 8 with which the operation of the stairlift as a whole can be controlled. Such a control 8 thus acts on the drive (not shown) of the stairlift.

Two guide mechanisms 9 are arranged between frame 2 and seat part 3. Each guide mechanism 9 comprises two arms 10 arranged pivotally on frame 2 and pivotally on seat 3, wherein the pivot points of these arms 10 form two parallelograms on either side of seat part 3. Due to the bend in the arms 10 and the form of the created parallelogram, the arms 11 are shorter than the effective distance between the pivot points arranged on seat 3 and the pivot points of arms 10 arranged on frame 2.

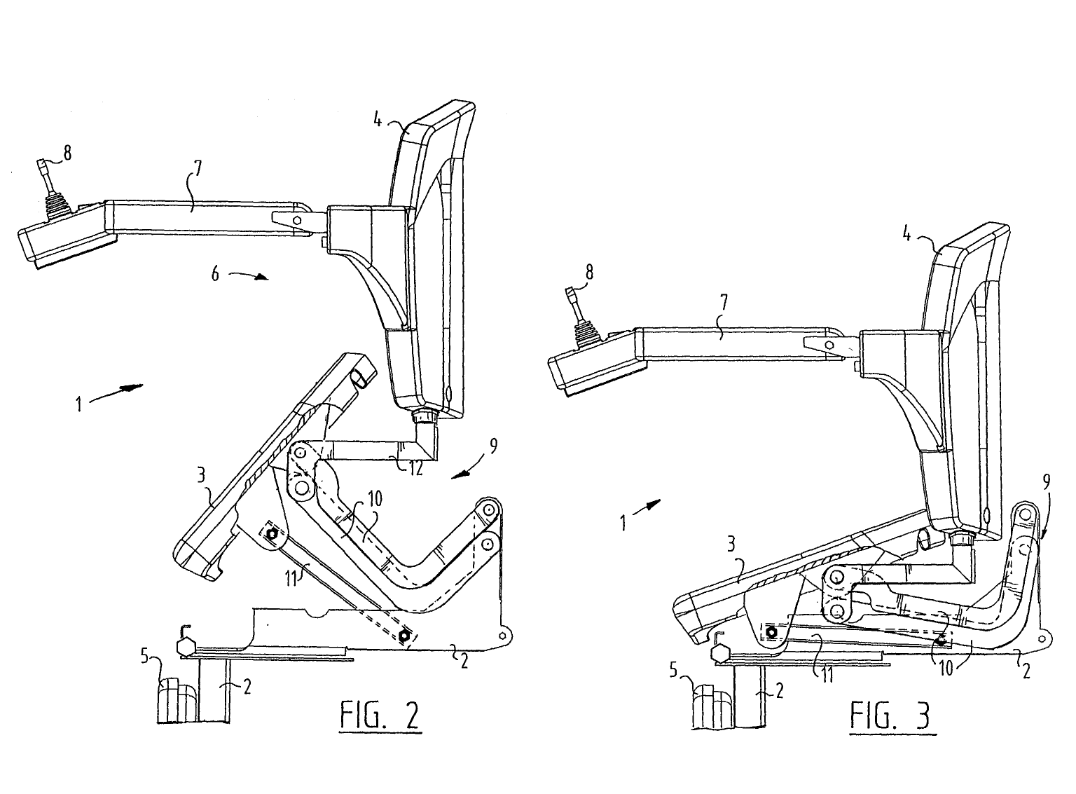

The operation of stairlift 1 is shown in side view in FIGS. 2 and 3, wherein it is noted that here footrest 5 is folded up against frame 2.

In the folded-up situation of seat part 3 of FIG. 2 the seat part is folded up as a result of said dimensioning and co-action between the arms 10 (with which the parallelogram is formed) and the arms 11 on the rear side thereof, i.e. the side of the back rest. When seat part 3 moves downward to the position as shown in FIG. 3, the seat part tilts on a nor-stationary tilt axis defined by the co-action between arms 10 and 11, as is the displacement of this tilt axis. The seat part thus descends from the folded-up position shown in FIG. 2 via the intermediate position shown in FIG. 3 to a wholly level folded-down position, which is not shown per se but will be apparent from the sequence of movements, and vice versa. Seat part 3 in any case thus forms a guide during standing up or sitting down.

The arms forming the parallelogram cause the upward movement, while it is substantially the arms 11, which fulfil a pull rod function, which bring about the tilting movement of seat part 3. Owing to the shown configuration the seat part 3 follows in ideal manner the ergonomic movement of a person who is standing up or sitting down, wherein the tilt axis follows the legs of a user approximately in or at least as close as possible to the pivot point of the pelvis thereof, so that the seat surface continues to support and guide the upper legs and the back rest the back of a user during standing or sitting in each intermediate position during these movements. For this purpose the arms 10 are curved, which also entails the arms 10 extending along seat part 3 on the rear side thereof, thereby achieving space-saving in the folded-down state of the seat part. A further space-saving is brought about in that arms 10 and arms 11 have a flat and plate-like design, so that they are folded up or folded in adjacently of each other in the downward tilted situation of seat part 3.

The back rest and the arm rests thereon fold up together with seat part 3, for which purpose a fixing rod 12 is coupled pivotally to the pivot points of arms 10 connected to seat part 3, whereby the back rest can co-displace in upright position up and downward with the movement of seat part 3, irrespective of the position of seat part 3. Back rest 4 and seat part 3 are thus also connected by means of guide mechanism 9.

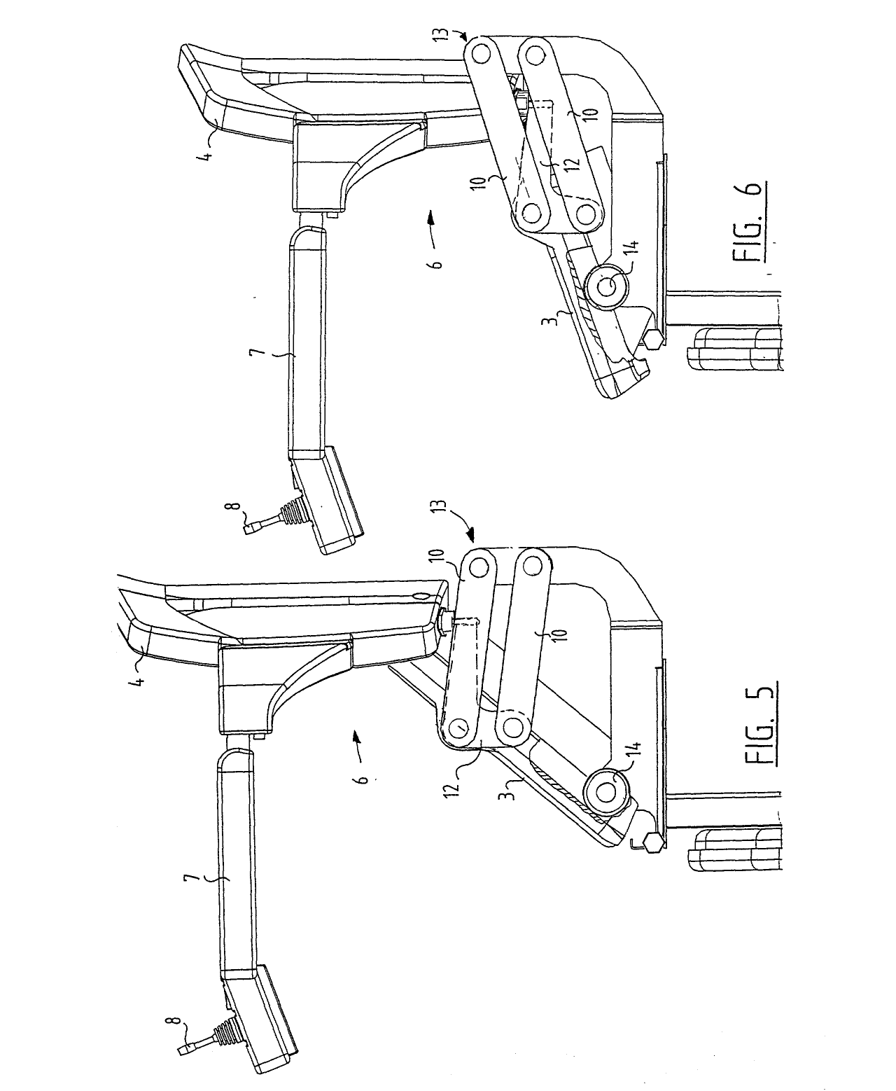

As noted, the embodiment of FIGS. 4-6 differs from that of FIGS. 1-3 substantially due to the configuration of the guide mechanisms, which are designated in FIGS. 4-6 with numeral 13. Use is also made in this embodiment of two arms 10 forming parallelograms, but without additional arms 11 of FIGS. 1-3 which fulfill a pull rod function. In the embodiment shown here the front edge of seat part 3 is connected rotatably to frame 2. The pivot axis is therefore stationary in the embodiment shown here, as also shown in FIGS. 5 and 6. The pivot axis is designated here with 14 and shifts under seat part 3 when this latter is pivoted up or downward.

The pivot points of arms 10 associated with seat part 3 are situated respectively above and below the seat surface defined by seat part 3. In such a configuration the seat surface also follows the standing or sitting movement of a user in ergonomic manner, although with less emphasis on height displacement. Such an embodiment is thus more suitable for instance for people who are not so tall.

FIGS. 7-9 show a still further simplified configuration which still shows a strong resemblance to that of FIGS. 4-6. The parallelogram-forming configuration of arms 10, which form a guide mechanism 15, is here essentially reversed, wherein the pivot points of arms 10 connected to frame 2 are situated at the front of seat part 3, while the pivot points of arms 10 connected to seat part 3 are situated at the rear of seat part 3. A practically ideal tilting movement of seat part 3 thus takes place and the parallelogram-forming configuration of guide mechanism 15 serves substantially to hold the back rest upright during the movement together with seat part 3. In contrast to the configuration of FIGS. 4-6, the seat part 3 does not therefore shift relative to the tilt axis on which it momentarily rotates.

It is noted that an arm 10 located closest to seat part 3 can be fixedly attached to the seat part.

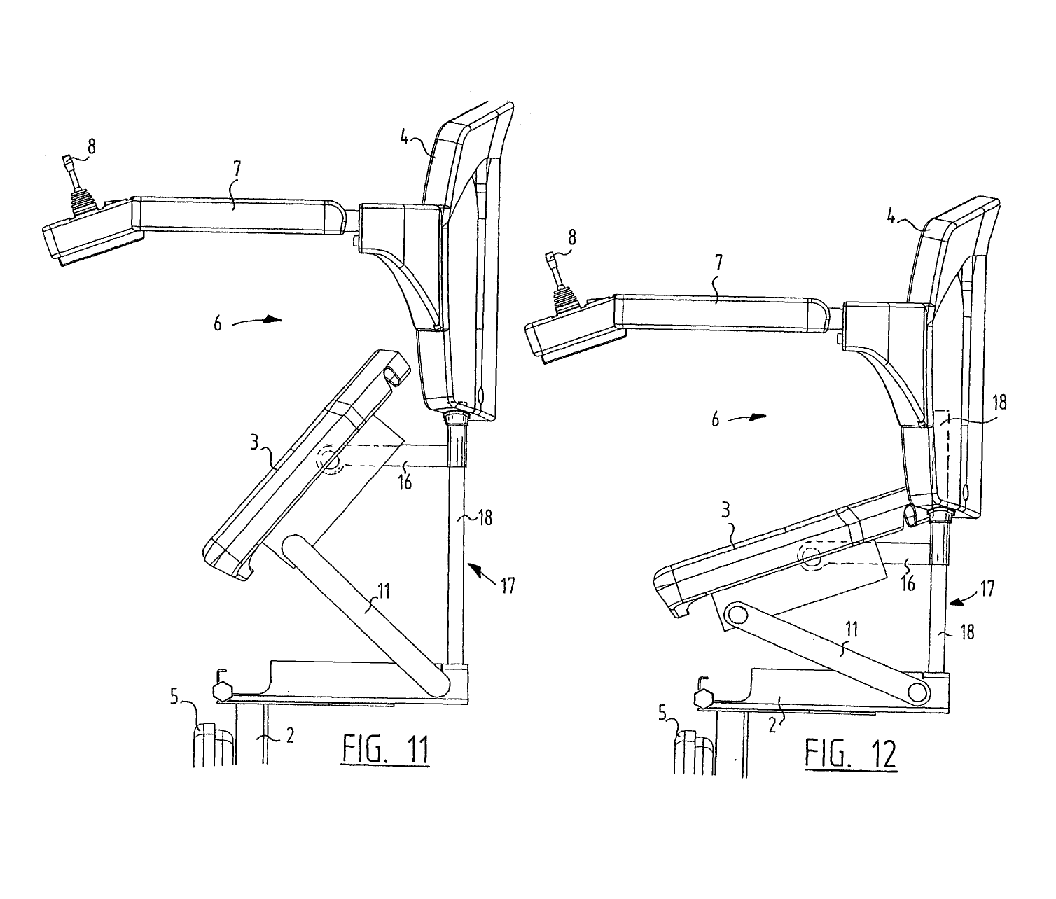

In contrast to the foregoing embodiments, no parallelogram-forming guide mechanism is used in the embodiment of FIGS. 10-12, but a slide rod 16 is applied in guide mechanism 17. Again used in guide mechanism 17 in addition to slide rod 16 is a pull rod, which in this case is longer than slide rod 16. Slide rod 16 slides upward, carrying with it the back rest 4, along a guide rod 18 to the position shown in FIG. 11. Pull rod 11 herein pulls the seat part into inclining position, since slide rod 16 is connected pivotally to seat part 3, as is pull rod 11.

During a downward movement of seat part 3 the guide rod 18 is received, as shown in FIG. 12, in back rest 4, which for this purpose is hollow or contains recesses for receiving guide rod 18.

After examination of the foregoing, many alternative and additional embodiments will occur to the skilled person which all lie within the scope of the definition of the invention as according to the appended claims. In some configurations of particularly the guide mechanism for the pivoting movement of at least the seat part relative to the frame, a weight displacement of the user is for instance enough to initiate or cause the tilting movement, while in other configurations a separate drive is desirable or essential. Such a seat drive can be connected to the same power supply as that used for the drive for moving the stairlift along the guide. An embodiment which is not further described can also comprise a lock to hold the seat, and in particular the seat surface thereof, locked during transport along the guide of the device. Additionally or alternatively, a blocking may be used which renders the drive of the device for movement along the guide inoperative when the chair does not rest on the frame in the folded-down position. Such locks and blockings are not further described in the foregoing, but implementation thereof lies well within the reach of a person with ordinary skill in the art. In embodiments where use is made of an active chair drive to pivot the seat part of the chair, the control, which normally serves to displace the stairlift along the guide of the device, can be augmented so as to also control driving of the chair.

In the foregoing description of explicit embodiments, it is preferably ensured in each case that the back rest, and optionally the arm rest, also co-displaces. Although this is very desirable from safety considerations, this measure could be dispensed with. It is noted that the guiding function during standing up and sitting on the chair of the device is described with diverse degrees of freedom in the foregoing, in FIGS. 1-3 pivoting, upward and forward; in FIGS. 4-6 pivoting and upward; in FIGS. 7-10 practically only pivoting; and in FIGS. 10-12 upward and pivoting, and vice versa for sitting down. In addition to the thus outlined options, any random combination of movements can be realized subject to the guide mechanism, wherein it is noted that following a natural movement of a user in ergonomically responsible manner during standing or sitting is of course preferred.

1. Device for transporting persons along a staircase, comprising:
a frame displaceable along a guide,
a drive to be selectively set into operation for displacing the frame along the guide; and
a chair on the frame on which a person for transporting can be seated,
wherein the chair comprises a seat part and a back rest, wherein at least the seat part on the side directed toward the back rest can be pivoted up and downward in a pivoting movement on a substantially horizontal pivot axis and forms a guide during standing up or sitting down.

2. Device as claimed in claim 1, wherein the back rest is connected to the seat part and co-displaces in substantially upright position with the seat part.

3. Device as claimed in claim 1 or 2, wherein the frame and the seat part are connected to a guide mechanism for guiding the movement of the seat part relative to the frame.

4. Device as claimed in claims 2 and 3, wherein the back rest and the seat part are connected by means of the guide mechanism.

5. Device as claimed in claim 3 or 4, wherein the guide mechanism comprises a chair drive.

6. Device as claimed in claim 3, 4 or 5, wherein the guide mechanism comprises a rod construction coupled by means of hinges.

7. Device as claimed in claim 6, wherein rods in the rod construction are flat and plate-like and fold adjacently of each other into the guide mechanism in a position of the seat part folded down onto the frame.

8. Device as claimed in claim 6 or 7, wherein the hinges in the rod construction form a parallelogram, of which two hinges lying at corner points of the parallelogram are fixed to the frame in stationary manner relative thereto, and the other two hinge points are coupled to the seat surface.

9. Device as claimed in claim 8, wherein the rods between the two sets of pivot points have a curved form.

10. Device as claimed in claim 8 or 9, wherein the back rest is coupled to the two remaining pivot points.

11. Device as claimed in any of the claims 3-8, wherein the guide mechanism comprises a pull rod which is arranged for rotation on the frame at the rear of the seat part and for rotation on the seat part at the front.

12. Device as claimed in any of the claims 3-8, wherein the guide mechanism defines a non-stationary horizontal pivot axis which during the pivoting movement substantially follows the movement in space of pivot points of legs of a user in the pelvis thereof.

13. Device as claimed in any of the foregoing claims, further comprising a lock to be actuated selectively and acting on at least the seat part, which lock is to be actuated during transport of the frame with the chair thereon along the guide.

14. Device as claimed in any of the foregoing claims, further comprising a blocking to be actuated selectively and acting on the frame, which blocking is to be actuated to prevent transport along the guide if the seat part is not situated in a position folded down on the frame.

15. Device as claimed in any of the foregoing claims, further comprising at least one arm rest.

16. Device as claimed in claims 2 and 15, wherein the arm rest is connected to the seat part and codisplaces in substantially upright position with the seat part.

17. Device as claimed in claim 16, wherein the arm rest is arranged on the back rest and is connected via the back rest to the seat part.

18. Device as claimed in claims 3 and 16, wherein the arm rest is connected to the guide mechanism and is connected via the guide mechanism to the seat part.
